(19) United States
(12) Patent Application Publication
(10) Pub. No.: US 2023/0195511 A1
(43) Pub. Date: Jun. 22, 2023

(54) ENERGY-EFFICIENT CRYPTOCURRENCY MINING HARDWARE ACCELERATOR WITH SPATIALLY SHARED MESSAGE SCHEDULER

(71) Applicant: Intel Corporation, Santa clara, CA (US)

(72) Inventors: Vikram Suresh, Portland, OR (US); Amitkumar Patel, San Jose, CA (US); Chandra S. Katta, Cupertino, CA (US); Sanu Mathew, Portland, OR (US); Long Sheng, Shanghai (CN)

(73) Assignee: Intel Corporation, Santa Clara, CA (US)

(21) Appl. No.: 17/710,746

(22) Filed: Mar. 31, 2022

Related U.S. Application Data
(60) Provisional application No. 63/293,010, filed on Dec. 22, 2021.

(51) Int. Cl. G06F 9/48; H04L 9/06

(52) U.S. Cl. CPC G06F 9/4843; H04L 9/0643; G06F 12/124

(57) ABSTRACT

Methods and apparatus relating to techniques for an energy-efficient cryptocurrency (e.g., Bitcoin) mining hardware accelerator with a spatially shared message scheduler are described. In an embodiment, a plurality of mining engines perform one or more operations for a cryptocurrency. A single scheduler processes a first portion of a message for two or more mining engines of the plurality of mining engines and pre-computation logic circuitry processes a second portion of the message for the two or more mining engines. Other embodiments are also disclosed and claimed.

### RELATED APPLICATION

The present application relates to and claims priority from U.S. Provisional Patent Application, Ser. No. 63/293,010, filed Dec. 22, 2021, entitled “ENERGY EFFICIENT CRYPTOCURRENCY MINING HARDWARE ACCELERATOR WITH TEMPORALLY SHARED MESSAGE SCHEDULER.”

### FIELD

The present disclosure generally relates to the field of computing systems. More particularly, some embodiments relate to techniques to provide an energy-efficient cryptocurrency (e.g., Bitcoin) mining hardware accelerator with spatially shared message scheduler.

### BACKGROUND

Bitcoin is currently the most popular digital currency used for peer-to-peer transactions, eliminating the need for intermediate financial institutions by guaranteeing authenticity and user anonymity using digital signatures. It solves the critical issue of “double spending” using the concept of block chaining, where a public ledger (sometimes also referred to as a “block chain” or “blockchain”) captures all the transactions that occur in the digital currency system.

In turn, every block added to the chain validates a new set of transactions by compressing the Merkle root of the transactions along with information including a time stamp, version, target, and the hash of the previous block. Generally, a Merkle root is a simple mathematical way to verify the data on a Merkle tree. Merkle roots are used in cryptocurrency to ensure data blocks passed between peers on a peer-to-peer network are whole, undamaged, and unaltered. The process of validating transactions and computing new blocks of the chain is known as “mining.”

### BRIEF DESCRIPTION OF THE DRAWINGS

So that the manner in which the herein recited features of the present embodiments can be understood in detail, a more particular description of the embodiments may be had by reference to embodiments, some of which are illustrated in the appended drawings. It is to be noted, however, that the appended drawings illustrate only typical embodiments and are therefore not to be considered limiting of their scope.

FIG. 1 illustrates a high-level block diagram of a Bitcoin mining accelerator system, which may be used in one or more embodiments.

FIG. 2 illustrates a high-level block diagram of a Bitcoin mining Application Specific Integrated Circuit (ASIC) system, which may be used in one or more embodiments.

FIG. 3 illustrates a block diagram of a system for version unrolling in energy-efficient Bitcoin mining, according to an embodiment.

FIG. 4 illustrates a block diagram of a system with spatially shared message scheduler to support version unrolling, according to an embodiment.

FIG. 5 illustrates a block diagram of a system to provide a spatially shared message scheduler, according to an embodiment.

FIG. 6A is a block diagram illustrating both an exemplary in-order pipeline and an exemplary register renaming, out-of-order issue/execution pipeline according to embodiments.

FIG. 6B is a block diagram illustrating both an exemplary embodiment of an in-order architecture core and an exemplary register renaming, out-of-order issue/execution architecture core to be included in a processor according to embodiments.

FIG. 7 illustrates a block diagram of an SOC (System On Chip) package in accordance with an embodiment.

FIG. 8 is a block diagram of a processing system, according to an embodiment.

FIG. 9 is a block diagram of an embodiment of a processor having one or more processor cores, according to some embodiments.

FIG. 10 is a block diagram of a graphics processor, according to an embodiment.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

As mentioned above, creating a public ledger and mining are key operations that ensure a secure implementation for Bitcoins. Moreover, in terms of computing costs, one of the (if not the) most expensive operation in mining involves the computationally intensive task of finding a 32-bit nonce, which when appended to the Merkle root, previous hash and other headers, produces a 256-bit hash value which is less than a pre-defined threshold value. As discussed herein, a “nonce” generally refers to an arbitrary number that is pseudo-randomly generated and can be used just once in a cryptographic communication. A nonce is often a random or pseudo-random number issued in an authentication protocol, for example, to ensure that old communications cannot be reused in replay attacks. In the case of Bitcoin mining, the nonce is used as a pseudorandom input to the proof-of-work. The hashing operation is the largest recurring cost a miner generally incurs in the process of creating a Bitcoin and therefore there is a strong motivation to reduce the energy consumption of this process. To address this issue, some highly parallelizable mining workloads may use dedicated ASICs (Application Specific Integrated Circuits) with many (e.g., hundreds) of mining engines working in parallel.

Some embodiments provide techniques for provision of an energy-efficient cryptocurrency (e.g., Bitcoin) mining hardware accelerator with spatially shared message scheduler. In at least one embodiment, a Bitcoin-optimized fully-unrolled Secure Hash Algorithm 2 or SHA-2 (including, for example, SHA256, sometimes also referred to as “SHA-256”) datapath with a four-way spatially shared message scheduler is provided. The proposed techniques are scalable for an n-way shared scheduler. Further, while some embodiments herein are discussed with reference to “Bitcoin,” embodiments are not limited to Bitcoin and the techniques discussed herein may be applied to any cryptocurrency, including Bitcoin, Ethereum, Binance Coin, Tether, Solana, etc.

By contrast, conventional Bitcoin mining accelerators do not support version unrolling. Even if they were to do so, version unrolling would likely be implemented by routing the scheduler output from one of the mining engines to two or more other engines, while their schedulers are clock/power gated. Moreover, in recent years, version unrolling has been adopted as a default mode in most mining pools, so it would be beneficial for mining ASICs to support this mode. The main disadvantages of using conventional mining engines to implement version unrolling is large spatial signal routing, leakage of unused scheduler logic, and an overall suboptimal area efficiency.

To this end, in at least one embodiment, a unified Bitcoin mining engine with a spatially shared message scheduler is provided. This design is further optimized to support a version unrolling mode and/or a shared common pre-compute component and programmable register interface in various embodiments. The unified, self-contained version unrolling implementation may be optimized for area and/or energy efficiency. In some embodiments, the shared common scheduler results in an approximately 20% area improvement, while providing an approximately 10% improvement in energy efficiency. The unified design combines two or more (e.g., double hash) mining engines, all sharing common pre-compute circuitry, programmable registers and a result First In, First Out (FIFO) buffer, decreasing peripheral overhead and significantly reducing programming complexity for the system software.

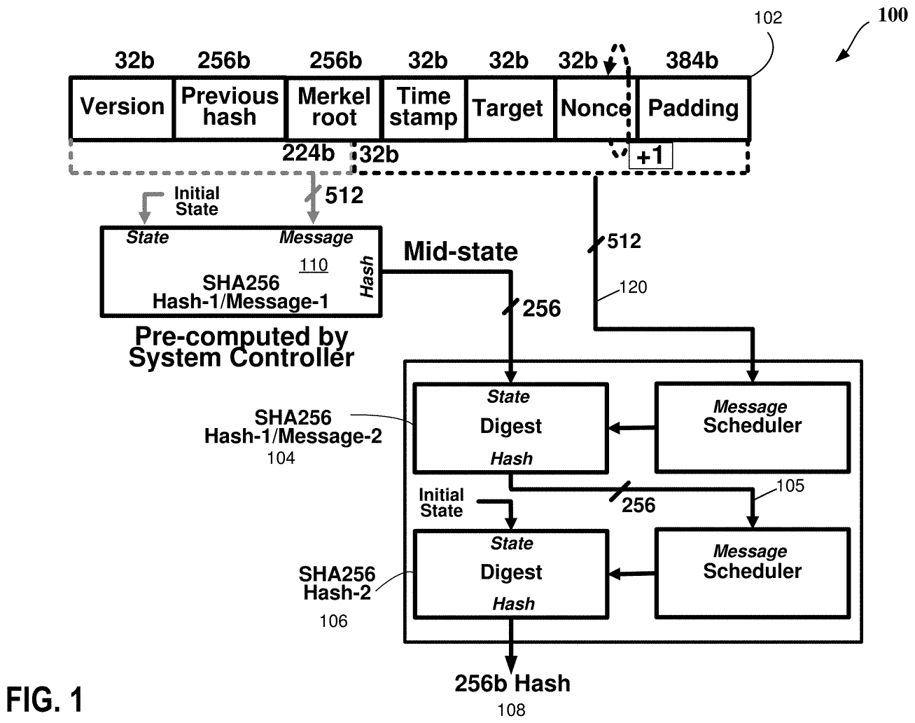

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc.

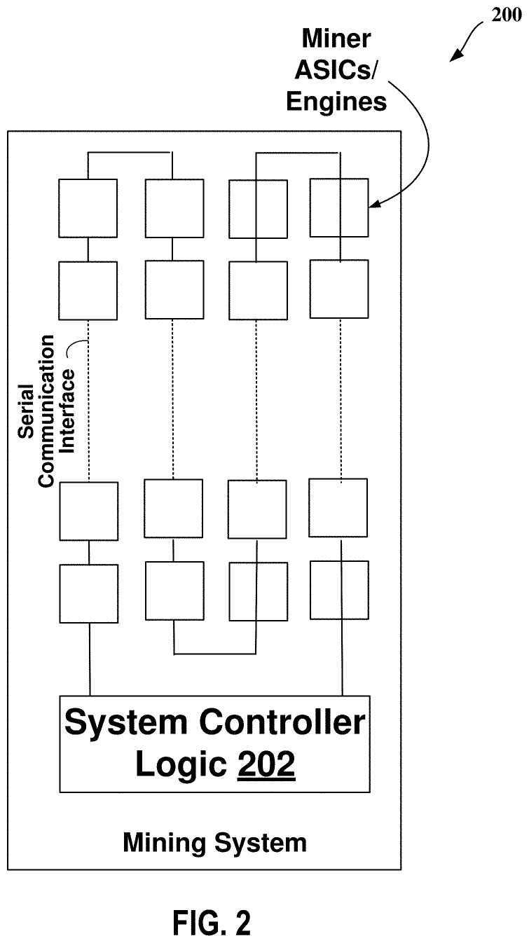

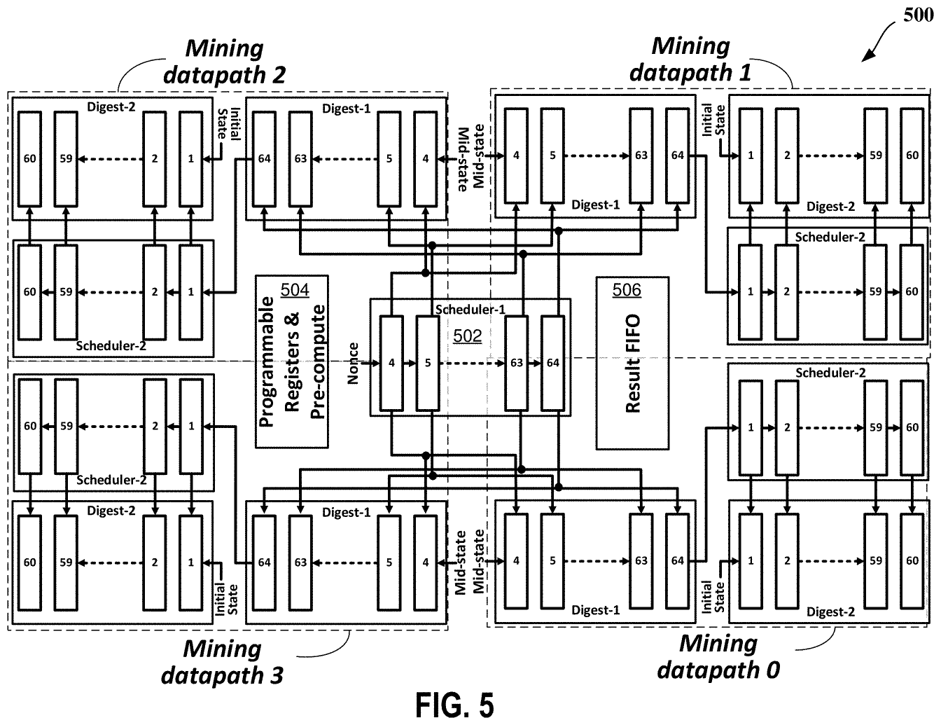

FIG. 1 illustrates a high-level block diagram of a Bitcoin mining accelerator system 100, which may be used in one or more embodiments. The Bitcoin mining process starts with a 1024-bit message 102 including a 32-bit version value, a 256-bit hash from the previous block, a 256-bit Merkle root of the transaction, a 32-bit time stamp, a 32-bit target value, a 32-bit nonce, and a 384-bit padding, e.g., per the SHA256 specification (where “SHA” refers to Secure Hash Algorithm and “SHA-256” refers to SHA, 256-bits). System 100 compresses the 1024-bit message 102 using two stages of 64-round SHA256 (stage-0 110 and stage-1 104) to generate a 256-bit hash 105 (which may be done in an ASIC in an embodiment). Hash 105 is padded with a 256-bit constant and is compressed again to obtain the final 256-bit hash result 108 (where the hash result 108 may be stored in a buffer such as the First In, First Out (FIFO) buffer 506 of FIG. 5). In an embodiment, stage-0 110 may be pre-computed by circuitry (such as system controller logic 202 of FIG. 2 and/or pre-computation circuitry 504 of FIG. 5)

Generally, the process of mining includes identifying a nonce for a given header which generates a final hash that is lesser than a pre-defined target. This is often achieved by looking for a minimum number of leading zeros that would ensure the hash to be smaller than the target. The target (and hence the leading zero requirement) changes depending on the rate of new block creation to maintain the rate at one block every 10 minutes, for example. Decreasing the target decreases the probability of finding a valid hash and hence increases the overall search space to generate a new block for the chain.

For a given header, the mining accelerator system 100 sweeps through the search space of 2³² options to potentially find a valid nonce. If no valid nonce is found, the Merkle root may be changed by choosing a different set of pending transactions and starting over with the nonce search. The SHA256 Stage-0 110 (computing the mid-state) is performed once per Merkle root and can be implemented either in a one-time hashing hardware accelerator or in software, or combinations thereof. The nonce space exploration in SHA256 Stage-1 (104) and Stage-2 (106) are implemented as fully unrolled 64 rounds of SHA256 message digest and parallel message expansion logic circuitry. Each stage of SHA256 can include 64-rounds each of message digest and message scheduler logic. Further details of FIG. 1 are discussed below.

Each mid-state computed in SHA256 Hash-1 (110) becomes the initial state for a mining workload, while the lower 512-bits of the header (120) becomes the message. In an embodiment, version unrolling chooses multiple 32-bit values for the version field, while keeping the rest of the fields the same.

FIG. 2 illustrates a high-level block diagram of a Bitcoin mining ASIC system 200, which may be used in one or more embodiments. Although a block target is generally set by global block chain parameters, individual mining pools may set a smaller target value to monitor the compute capacity of each mining system connected to the pool. In turn, each mining system may set a smaller engine target to monitor the performance of mining engines. Each of these targets are verified by verifying if the hash value computed has a certain number of leading zeros. The probability of finding a valid nonce by an engine is proportional to 1/(2 to the power of the number of leading zeros) and hence directly affects the data traffic between the engines/ASICs and the system controller 202, as well as the observability of each engine.

Moreover, the block target and the pool target can be modified frequently depending on the overall hash-rate of the Bitcoin network. If the engine target is fixed at a small value, a large number of invalid hash values can be sent back to the system controller 202 only to be discarded once compared to a share target 102. For instance, if the engine target requires 32 leading zeros and the share target requires 48 leading zeros, only 1 in 2¹⁶ or 0.0015% of results sent from a miner ASIC or engine to the system controller 202 will be sent to the pool. This results in a large amount of data movement between the ASIC and system controller, without yielding any valuable result.

To verify the large number of results, the capacity of the system controller also needs to be increased, necessitating a larger and more expensive Field-Programmable Gate Array (FPGA) or microcontroller. On the other hand, if the engine target is set too high, the system controller 202 will receive very few responses back from the miner ASICs or engines, limiting its ability for debug and performance tuning.

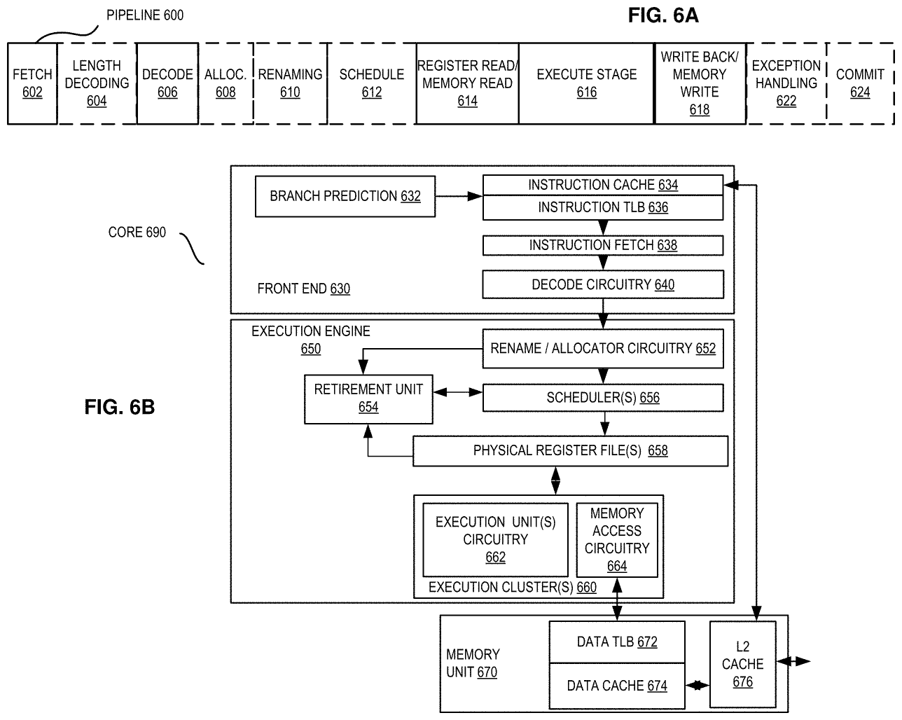

Moreover, while system 200 is indicated to utilize ASICs and mining agents, embodiments are not limited to this and processors, having one or more processor cores, such as those discussed with reference to FIG. 6, et seq. may be utilized to perform one or more operations discussed herein. As an example, each core of a processor may be used as a miner engine and interconnects may be used to communicate between these cores instead of or in addition to the serial communication interfaces.

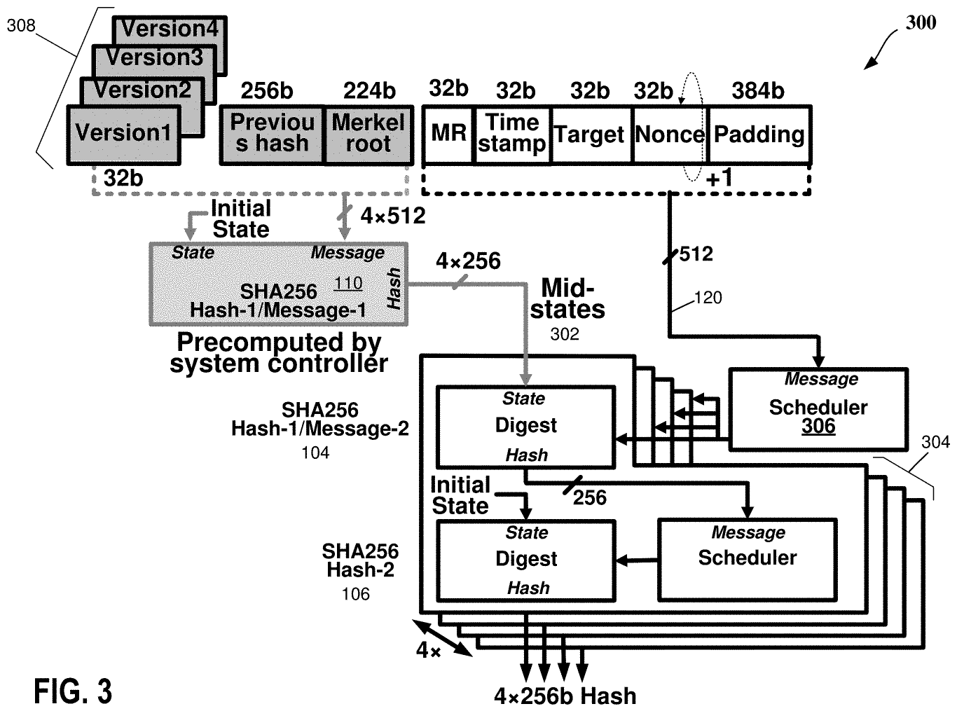

FIG. 3 illustrates a block diagram of a system 300 for version unrolling in energy-efficient Bitcoin mining, according to an embodiment. System 300 generates multiple mid-states 302 (four shown) which all share the same message 120 transmitted to the mining engines 304 via the message scheduler 306. The message scheduler 306 operates on this 512-bit input message and expands the input message to compute a new 32-bit message word for rounds 17-64 of the SHA256 operation. As a result, all the digest datapaths consuming these mid-states receive the same input message from a common shared scheduler 306 as shown in FIG. 3. Version unrolling (of versions 308) eliminates the scheduler stage-1 switching activity in “n−1” engines for n-way version unrolling. Also, while some embodiments only discuss four versions and/or groups of four mining engines, embodiments are not limited to four versions or four mining engines and techniques discussed herein may be applied to any number of versions or mining engines.

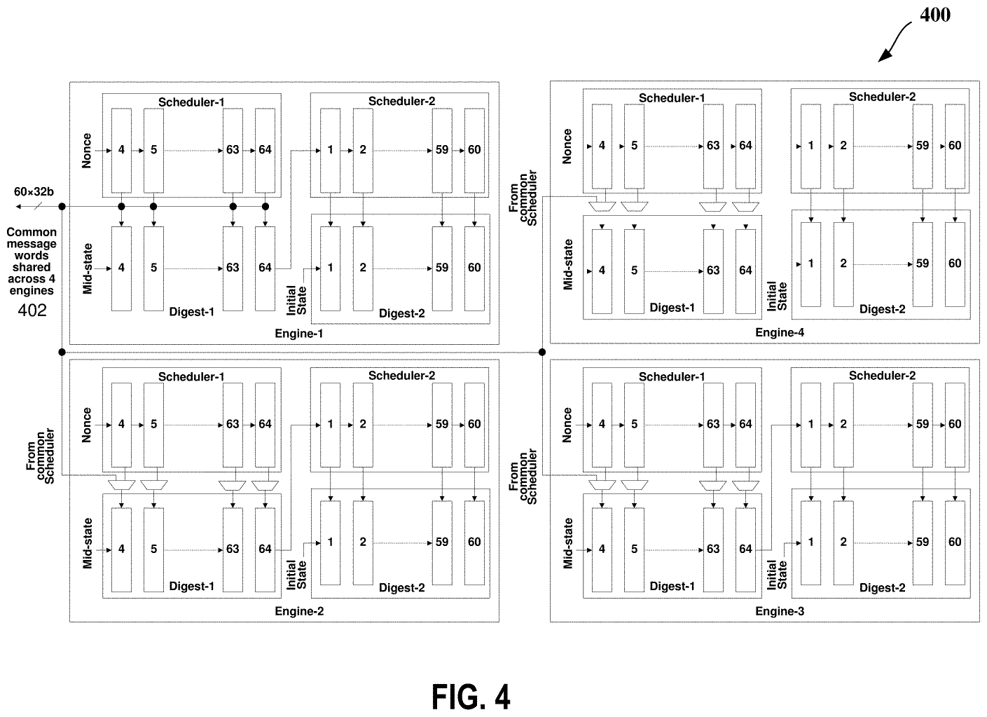

FIG. 4 illustrates a block diagram of a system 400 with a spatially shared message scheduler to support version unrolling, according to an embodiment. Some conventional Bitcoin miners include mining engines that perform a double hash operation. In an embodiment, to support version unrolling, the output of a first scheduler in one of the engines (402) is shared across multiple other engines as shown in FIG. 4.

Moreover, with mining pools moving to version unrolled workload deployment, gated schedulers add to leakage power and lower area efficiency of the ASIC. The wasted engine area results in significant routing overhead to transfer signals between engines. Along with routing overhead, spatial scheduler sharing also requires careful scheduling of mining workloads across multiple engines and precise clock synchronization to minimize any performance overhead.

FIG. 5 illustrates a block diagram of a system 500 to provide a spatially shared message scheduler, according to an embodiment. System 500 provides a unified mining engine system with n-way spatially shared message scheduler.

Referring to FIGS. 3, 4, and 5, in at least one embodiment, a unified mining accelerator implementing more than two double hash datapaths in the same mining engine is provided. As shown in FIG. 5, a common scheduler-1 502 (such as scheduler 306 of FIG. 3) works on the lower 512 bits of the Bitcoin mining message (e.g., message 120 of FIG. 3), providing new message words to two or more digests (labeled “Digest-1” and “Digest-2” in each engine shown in FIGS. 4 and 5), each of which operate on a unique mid-state (e.g., one of mid-states 302 of FIG. 3). The unified engine design can provide a sizeable area and/or leakage power improvement by eliminating extra scheduler logic blocks. The reduced area also helps in minimizing wiring overhead for spatially shared scheduler. Along with the shared scheduler (502), this unified design also shares programmable registers that are used by the software to configure the mining operation—such as the number of leading zeros and time stamp unrolling, along with pre-computation circuitry 504 to perform the first three rounds of digest operation in the mining engine (which may be the same or similar to stage 110 of FIG. 1), and a result First In, First Out (FIFO) buffer 506. While these peripheral slow speed logics do not contribute much to the dynamic energy usage, they still account for approximately 5% of engine area and leakage power. For a unified mining engine with a four-way spatially shared scheduler, the overhead of peripheral logic is reduced by approximately 75% by amortizing the cost across four mining datapaths, instead of one. Shared programmable registers and result FIFO buffers also minimize the book-keeping overhead for the system software, which now deals with fewer end point engines.

Additionally, some embodiments may be applied in computing systems that include one or more processors (e.g., where the one or more processors may include one or more processor cores), such as those discussed with reference to FIG. 1 et seq., including for example a desktop computer, a workstation, a computer server, a server blade, or a mobile computing device. The mobile computing device may include a smartphone, tablet, UMPC (Ultra-Mobile Personal Computer), laptop computer, Ultrabook™ computing device, wearable devices (such as a smart watch, smart ring, smart bracelet, or smart glasses), etc. As an example, one or more processors or processor cores may be used to provide the mining engines and/or logic/controllers discussed with reference to FIGS. 1-5.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

FIG. 6A is a block diagram illustrating both an exemplary in-order pipeline and an exemplary register renaming, out-of-order issue/execution pipeline according to embodiments. FIG. 6B is a block diagram illustrating both an exemplary embodiment of an in-order architecture core and an exemplary register renaming, out-of-order issue/execution architecture core to be included in a processor according to embodiments. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, a length decode stage 604, a decode stage 606, an allocation stage 608, a renaming stage 610, a scheduling (also known as a dispatch or issue) stage 612, a register read/memory read stage 614, an execute stage 616, a write back/memory write stage 618, an exception handling stage 622, and a commit stage 624.

FIG. 6B shows processor core 690 including a front end unit 630 coupled to an execution engine unit 650, and both are coupled to a memory unit 670. The core 690 may be a reduced instruction set computing (RISC) core, a complex instruction set computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front end unit 630 includes a branch prediction unit 632 coupled to an instruction cache unit 634, which is coupled to an instruction translation lookaside buffer (TLB) 636, which is coupled to an instruction fetch unit 638, which is coupled to a decode unit 640. The decode unit 640 (or decoder) may decode instructions, and generate as an output one or more micro-operations, micro-code entry points, microinstructions, other instructions, or other control signals, which are decoded from, or which otherwise reflect, or are derived from, the original instructions. The decode unit 640 may be implemented using various different mechanisms. Examples of suitable mechanisms include, but are not limited to, look-up tables, hardware implementations, programmable logic arrays (PLAs), microcode read only memories (ROMs), etc. In one embodiment, the core 690 includes a microcode ROM or other medium that stores microcode for certain macroinstructions (e.g., in decode unit 640 or otherwise within the front end unit 630). The decode unit 640 is coupled to a rename/allocator unit 652 in the execution engine unit 650.

The execution engine unit 650 includes the rename/allocator unit 652 coupled to a retirement unit 654 and a set of one or more scheduler unit(s) 656. The scheduler unit(s) 656 represents any number of different schedulers, including reservations stations, central instruction window, etc. The scheduler unit(s) 656 is coupled to the physical register file(s) unit(s) 658. Each of the physical register file(s) units 658 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 658 comprises a vector registers unit, a writemask registers unit, and a scalar registers unit. These register units may provide architectural vector registers, vector mask registers, and general purpose registers. The physical register file(s) unit(s) 658 is overlapped by the retirement unit 654 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 654 and the physical register file(s) unit(s) 658 are coupled to the execution cluster(s) 660. The execution cluster(s) 660 includes a set of one or more execution units 662 and a set of one or more memory access units 664. The execution units 662 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 656, physical register file(s) unit(s) 658, and execution cluster(s) 660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 664). It should also be understood that where separate pipelines are used, one or more of these pipelines may be out-of-order issue/execution and the rest in-order.

The set of memory access units 664 is coupled to the memory unit 670, which includes a data TLB unit 672 coupled to a data cache unit 674 coupled to a level 2 (L2) cache unit 676. In one exemplary embodiment, the memory access units 664 may include a load unit, a store address unit, and a store data unit, each of which is coupled to the data TLB unit 672 in the memory unit 670. The instruction cache unit 634 is further coupled to a level 2 (L2) cache unit 676 in the memory unit 670. The L2 cache unit 676 is coupled to one or more other levels of cache and eventually to a main memory.

By way of example, the exemplary register renaming, out-of-order issue/execution core architecture may implement the pipeline 600 as follows: 1) the instruction fetch 638 performs the fetch and length decoding stages 602 and 604; 2) the decode unit 640 performs the decode stage 606; 3) the rename/allocator unit 652 performs the allocation stage 608 and renaming stage 610; 4) the scheduler unit(s) 656 performs the schedule stage 612; 6) the physical register file(s) unit(s) 658 and the memory unit 670 perform the register read/memory read stage 614; the execution cluster 660 perform the execute stage 616; 8) the memory unit 670 and the physical register file(s) unit(s) 658 perform the write back/memory write stage 618; 6) various units may be involved in the exception handling stage 622; and 8) the retirement unit 654 and the physical register file(s) unit(s) 658 perform the commit stage 624.

The core 690 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 690 includes logic to support a packed data instruction set extension (e.g., AVX1, AVX2), thereby allowing the operations used by many multimedia applications to be performed using packed data.

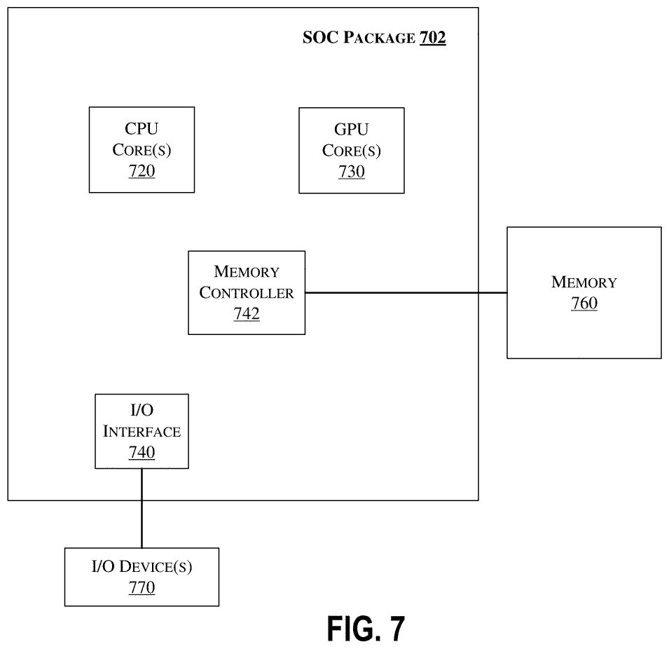

FIG. 7 illustrates a block diagram of an SOC package in accordance with an embodiment. As illustrated in FIG. 7, SOC 702 includes one or more Central Processing Unit (CPU) cores 720, one or more Graphics Processor Unit (GPU) cores 730, an Input/Output (I/O) interface 740, and a memory controller 742. Various components of the SOC package 702 may be coupled to an interconnect or bus such as discussed herein with reference to the other figures. Also, the SOC package 702 may include more or less components, such as those discussed herein with reference to the other figures. Further, each component of the SOC package 702 may include one or more other components, e.g., as discussed with reference to the other figures herein. In one embodiment, SOC package 702 (and its components) is provided on one or more Integrated Circuit (IC) die, e.g., which are packaged into a single semiconductor device.

As illustrated in FIG. 7, SOC package 702 is coupled to a memory 760 via the memory controller 742. In an embodiment, the memory 760 (or a portion of it) can be integrated on the SOC package 702.

The I/O interface 740 may be coupled to one or more I/O devices 770, e.g., via an interconnect and/or bus such as discussed herein with reference to other figures. I/O device(s) 770 may include one or more of a keyboard, a mouse, a touchpad, a display, an image/video capture device (such as a camera or camcorder/video recorder), a touch screen, a speaker, or the like.

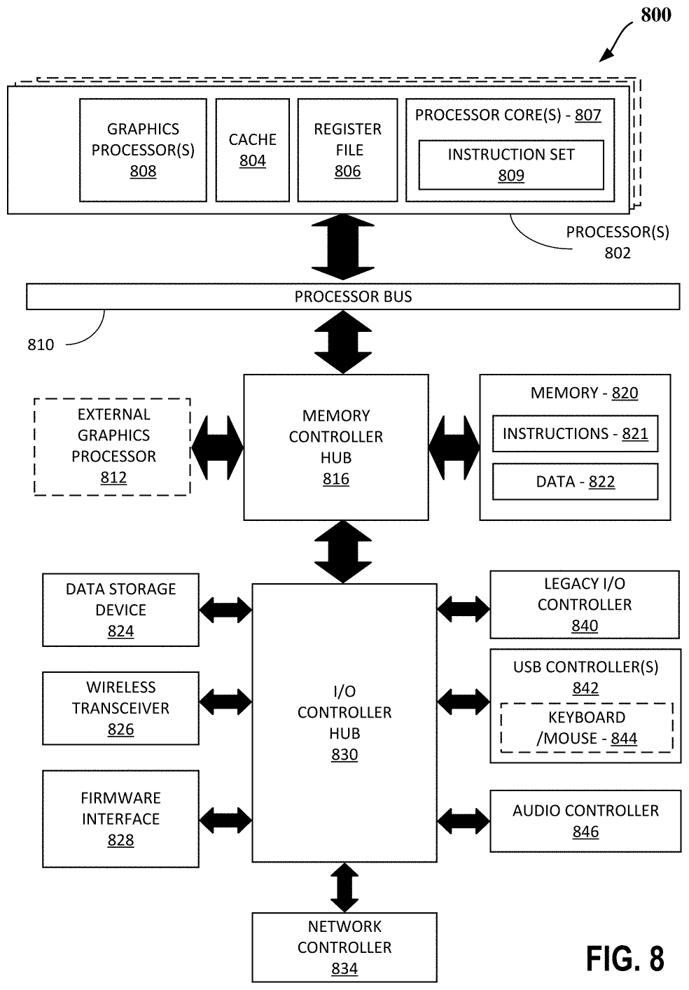

FIG. 8 is a block diagram of a processing system 800, according to an embodiment. In various embodiments the system 800 includes one or more processors 802 and one or more graphics processors 808, and may be a single processor desktop system, a multiprocessor workstation system, or a server system having a large number of processors 802 or processor cores 807. In on embodiment, the system 800 is a processing platform incorporated within a system-on-a-chip (SoC or SOC) integrated circuit for use in mobile, handheld, or embedded devices.

An embodiment of system 800 can include, or be incorporated within a server-based gaming platform, a game console, including a game and media console, a mobile gaming console, a handheld game console, or an online game console. In some embodiments system 800 is a mobile phone, smart phone, tablet computing device or mobile Internet device. Data processing system 800 can also include, couple with, or be integrated within a wearable device, such as a smart watch wearable device, smart eyewear device, augmented reality device, or virtual reality device. In some embodiments, data processing system 800 is a television or set top box device having one or more processors 802 and a graphical interface generated by one or more graphics processors 808.

In some embodiments, the one or more processors 802 each include one or more processor cores 807 to process instructions which, when executed, perform operations for system and user software. In some embodiments, each of the one or more processor cores 807 is configured to process a specific instruction set 809. In some embodiments, instruction set 809 may facilitate Complex Instruction Set Computing (CISC), Reduced Instruction Set Computing (RISC), or computing via a Very Long Instruction Word (VLIW). Multiple processor cores 807 may each process a different instruction set 809, which may include instructions to facilitate the emulation of other instruction sets. Processor core 807 may also include other processing devices, such a Digital Signal Processor (DSP).

In some embodiments, the processor 802 includes cache memory 804. Depending on the architecture, the processor 802 can have a single internal cache or multiple levels of internal cache. In some embodiments, the cache memory is shared among various components of the processor 802. In some embodiments, the processor 802 also uses an external cache (e.g., a Level-3 (L3) cache or Last Level Cache (LLC)) (not shown), which may be shared among processor cores 807 using known cache coherency techniques. A register file 806 is additionally included in processor 802 which may include different types of registers for storing different types of data (e.g., integer registers, floating point registers, status registers, and an instruction pointer register). Some registers may be general-purpose registers, while other registers may be specific to the design of the processor 802.

In some embodiments, processor 802 is coupled to a processor bus 810 to transmit communication signals such as address, data, or control signals between processor 802 and other components in system 800. In one embodiment the system 800 uses an exemplary ‘hub’ system architecture, including a memory controller hub 816 and an Input Output (I/O) controller hub 830. A memory controller hub 816 facilitates communication between a memory device and other components of system 800, while an I/O Controller Hub (ICH) 830 provides connections to I/O devices via a local I/O bus. In one embodiment, the logic of the memory controller hub 816 is integrated within the processor.

Memory device 820 can be a dynamic random access memory (DRAM) device, a static random access memory (SRAM) device, flash memory device, phase-change memory device, or some other memory device having suitable performance to serve as process memory. In one embodiment the memory device 820 can operate as system memory for the system 800, to store data 822 and instructions 821 for use when the one or more processors 802 executes an application or process. Memory controller hub 816 also couples with an optional external graphics processor 812, which may communicate with the one or more graphics processors 808 in processors 802 to perform graphics and media operations.

In some embodiments, ICH 830 enables peripherals to connect to memory device 820 and processor 802 via a high-speed I/O bus. The I/O peripherals include, but are not limited to, an audio controller 846, a firmware interface 828, a wireless transceiver 826 (e.g., Wi-Fi, Bluetooth), a data storage device 824 (e.g., hard disk drive, flash memory, etc.), and a legacy I/O controller 840 for coupling legacy (e.g., Personal System 2 (PS/2)) devices to the system. One or more Universal Serial Bus (USB) controllers 842 connect input devices, such as keyboard and mouse 844 combinations. A network controller 834 may also couple to ICH 830. In some embodiments, a high-performance network controller (not shown) couples to processor bus 810. It will be appreciated that the system 800 shown is exemplary and not limiting, as other types of data processing systems that are differently configured may also be used. For example, the I/O controller hub 830 may be integrated within the one or more processor 802, or the memory controller hub 816 and I/O controller hub 830 may be integrated into a discreet external graphics processor, such as the external graphics processor 812.

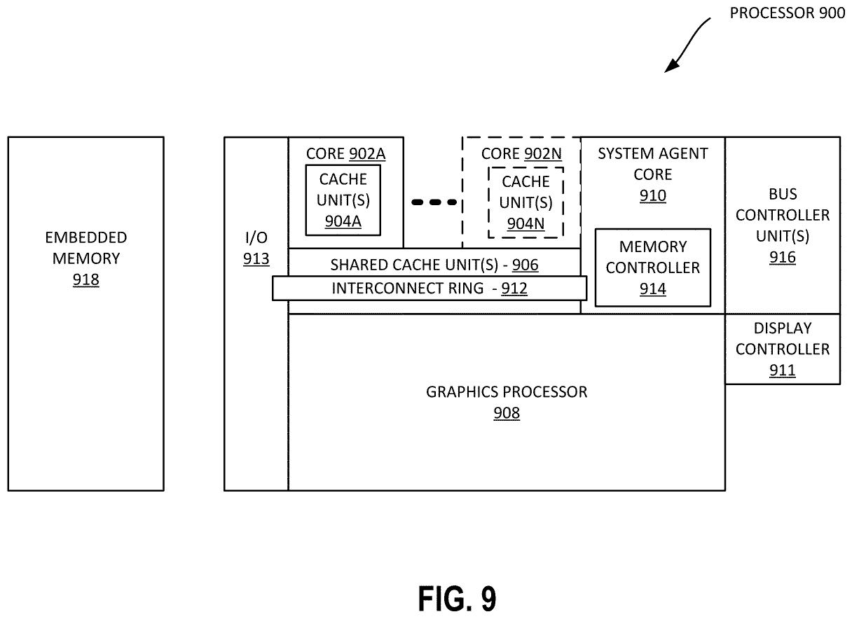

FIG. 9 is a block diagram of an embodiment of a processor 900 having one or more processor cores 902A to 902N, an integrated memory controller 914, and an integrated graphics processor 908. Those elements of FIG. 9 having the same reference numbers (or names) as the elements of any other figure herein can operate or function in any manner similar to that described elsewhere herein, but are not limited to such. Processor 900 can include additional cores up to and including additional core 902N represented by the dashed lined boxes. Each of processor cores 902A to 902N includes one or more internal cache units 904A to 904N. In some embodiments each processor core also has access to one or more shared cached units 906.

The internal cache units 904A to 904N and shared cache units 906 represent a cache memory hierarchy within the processor 900. The cache memory hierarchy may include at least one level of instruction and data cache within each processor core and one or more levels of shared mid-level cache, such as a Level 2 (L2), Level 3 (L3), Level 4 (L4), or other levels of cache, where the highest level of cache before external memory is classified as the LLC. In some embodiments, cache coherency logic maintains coherency between the various cache units 906 and 904A to 904N.

In some embodiments, processor 900 may also include a set of one or more bus controller units 916 and a system agent core 910. The one or more bus controller units 916 manage a set of peripheral buses, such as one or more Peripheral Component Interconnect buses (e.g., PCI, PCI Express). System agent core 910 provides management functionality for the various processor components. In some embodiments, system agent core 910 includes one or more integrated memory controllers 914 to manage access to various external memory devices (not shown).

In some embodiments, one or more of the processor cores 902A to 902N include support for simultaneous multi-threading. In such embodiment, the system agent core 910 includes components for coordinating and operating cores 902A to 902N during multi-threaded processing. System agent core 910 may additionally include a power control unit (PCU), which includes logic and components to regulate the power state of processor cores 902A to 902N and graphics processor 908.

In some embodiments, processor 900 additionally includes graphics processor 908 to execute graphics processing operations. In some embodiments, the graphics processor 908 couples with the set of shared cache units 906, and the system agent core 910, including the one or more integrated memory controllers 914. In some embodiments, a display controller 911 is coupled with the graphics processor 908 to drive graphics processor output to one or more coupled displays. In some embodiments, display controller 911 may be a separate module coupled with the graphics processor via at least one interconnect, or may be integrated within the graphics processor 908 or system agent core 910.

In some embodiments, a ring based interconnect unit 912 is used to couple the internal components of the processor 900. However, an alternative interconnect unit may be used, such as a point-to-point interconnect, a switched interconnect, or other techniques, including techniques well known in the art. In some embodiments, graphics processor 908 couples with the ring interconnect 912 via an I/O link 913.

The exemplary I/O link 913 represents at least one of multiple varieties of I/O interconnects, including an on package I/O interconnect which facilitates communication between various processor components and a high-performance embedded memory module 918, such as an eDRAM (or embedded DRAM) module. In some embodiments, each of the processor cores 902 to 902N and graphics processor 908 use embedded memory modules 918 as a shared Last Level Cache.

In some embodiments, processor cores 902A to 902N are homogenous cores executing the same instruction set architecture. In another embodiment, processor cores 902A to 902N are heterogeneous in terms of instruction set architecture (ISA), where one or more of processor cores 902A to 902N execute a first instruction set, while at least one of the other cores executes a subset of the first instruction set or a different instruction set. In one embodiment processor cores 902A to 902N are heterogeneous in terms of microarchitecture, where one or more cores having a relatively higher power consumption couple with one or more power cores having a lower power consumption. Additionally, processor 900 can be implemented on one or more chips or as an SoC integrated circuit having the illustrated components, in addition to other components.

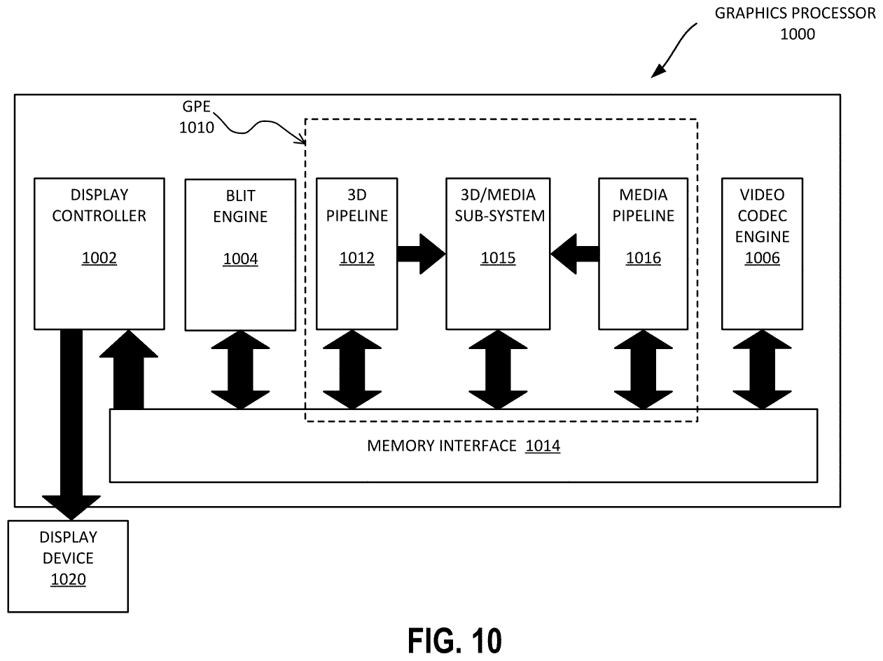

FIG. 10 is a block diagram of a graphics processor 1000, which may be a discrete graphics processing unit, or may be a graphics processor integrated with a plurality of processing cores. In some embodiments, the graphics processor communicates via a memory mapped I/O interface to registers on the graphics processor and with commands placed into the processor memory. In some embodiments, graphics processor 1000 includes a memory interface 1014 to access memory. Memory interface 1014 can be an interface to local memory, one or more internal caches, one or more shared external caches, and/or to system memory.

In some embodiments, graphics processor 1000 also includes a display controller 1002 to drive display output data to a display device 1020. Display controller 1002 includes hardware for one or more overlay planes for the display and composition of multiple layers of video or user interface elements. In some embodiments, graphics processor 1000 includes a video codec engine 1006 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 321M/VC-1, and Joint Photographic Experts Group (JPEG) formats such as JPEG, and Motion JPEG (MJPEG) formats.

In some embodiments, graphics processor 1000 includes a block image transfer (BLIT) engine 1004 to perform two-dimensional (2D) rasterizer operations including, for example, bit-boundary block transfers. However, in one embodiment, 10D graphics operations are performed using one or more components of graphics processing engine (GPE) 1010. In some embodiments, graphics processing engine 1010 is a compute engine for performing graphics operations, including three-dimensional (3D) graphics operations and media operations.

In some embodiments, GPE 1010 includes a 3D pipeline 1012 for performing 3D operations, such as rendering three-dimensional images and scenes using processing functions that act upon 3D primitive shapes (e.g., rectangle, triangle, etc.). The 3D pipeline 1012 includes programmable and fixed function elements that perform various tasks within the element and/or spawn execution threads to a 3D/Media sub-system 1015. While 3D pipeline 1012 can be used to perform media operations, an embodiment of GPE 1010 also includes a media pipeline 1016 that is specifically used to perform media operations, such as video post-processing and image enhancement.

In some embodiments, media pipeline 1016 includes fixed function or programmable logic units to perform one or more specialized media operations, such as video decode acceleration, video de-interlacing, and video encode acceleration in place of, or on behalf of video codec engine 1006. In some embodiments, media pipeline 1016 additionally includes a thread spawning unit to spawn threads for execution on 3D/Media sub-system 1015. The spawned threads perform computations for the media operations on one or more graphics execution units included in 3D/Media sub-system 1015.

In some embodiments, 3D/Media subsystem 1015 includes logic for executing threads spawned by 3D pipeline 1012 and media pipeline 1016. In one embodiment, the pipelines send thread execution requests to 3D/Media subsystem 1015, which includes thread dispatch logic for arbitrating and dispatching the various requests to available thread execution resources. The execution resources include an array of graphics execution units to process the 3D and media threads. In some embodiments, 3D/Media subsystem 1015 includes one or more internal caches for thread instructions and data. In some embodiments, the subsystem also includes shared memory, including registers and addressable memory, to share data between threads and to store output data.

In this description, numerous specific details are set forth to provide a more thorough understanding. However, it will be apparent to one of skill in the art that the embodiments described herein may be practiced without one or more of these specific details. In other instances, well-known features have not been described to avoid obscuring the details of the present embodiments.

The following examples pertain to further embodiments. Example 1 includes 1 includes an apparatus comprising: a plurality of mining engines to perform one or more operations for a cryptocurrency; a scheduler to process a first portion of a message for two or more mining engines of the plurality of mining engines; and pre-computation circuitry to process a second portion of the message for the two or more mining engines. Example 2 includes the apparatus of example 1, further comprising a First In, First Out (FIFO) buffer to store a hash result from the two or more mining engines. Example 3 includes the apparatus of any one of examples 1 to 2, further comprising a plurality of programmable registers shared amongst the two or more mining engines. Example 4 includes the apparatus of any one of examples 1 to 3, wherein the pre-computation circuitry is to process the second portion of the message by performing multiple rounds of hashing to compress the second portion of the message. Example 5 includes the apparatus of any one of examples 1 to 4, wherein the first portion of the message comprises a first set of bits from an upper half of the message. Example 6 includes the apparatus of any one of examples 1 to 5, wherein the second portion of the message comprises a second set of bits from a lower half of the message. Example 7 includes the apparatus of any one of examples 1 to 6, wherein the message comprises 1024 bits, wherein the first portion of the message comprises 512 bits from an upper half of the message. Example 8 includes the apparatus of any one of examples 1 to 7, wherein the message comprises 1024 bits, wherein the second portion of the message comprises 512 bits from a lower half of the message. Example 9 includes the apparatus of any one of examples 1 to 8, wherein each of the two or more mining engines are to perform at least two hashing operations. Example 10 includes the apparatus of any one of examples 1 to 9, wherein the at least two hashing operations are to be performed in accordance with a Secure Hash Algorithm (SHA). Example 11 includes the apparatus of any one of examples 1 to 10, wherein the one or more operations comprise one or more of: compression and hashing. Example 12 includes the apparatus of any one of examples 1 to 11, wherein the cryptocurrency is one of: a Bitcoin, Ethereum, Biance Coin, Tether, and Solana. Example 13 includes the apparatus of any one of examples 1 to 12, wherein mining system controller circuitry comprises the pre-computation circuitry. Example 14 includes the apparatus of any one of examples 1 to 13, wherein the plurality of mining engine each comprise at least one processor core. Example 15 includes the apparatus of any one of examples 1 to 14, wherein a processor, having one or more processor cores, comprises one or more of: the scheduler and the pre-computation circuitry.

Example 16 includes a method comprising: performing, at a plurality of mining engines, one or more operations to generate a cryptocurrency; processing, at a scheduler, a first portion of a message for two or more mining engines of the plurality of mining engines; and processing, at pre-computation circuitry, a second portion of the message for the two or more mining engines. Example 17 includes the method of example 16, further comprising storing a hash result from the two or more mining engines in a First In, First Out (FIFO) buffer. Example 18 includes the method of any one of examples 16 to 17, further comprising sharing a plurality of programmable registers amongst the two or more mining engines. Example 19 includes the method of any one of examples 16 to 18, further comprising the pre-computation circuitry processing the second portion of the message by performing multiple rounds of hashing to compress the second portion of the message.

Example 20 includes an apparatus comprising means to perform an operation as set forth in any preceding examples 1-19. Example 21 includes machine-readable storage including machine-readable instructions, when executed, to implement an operation or realize an apparatus as set forth in any preceding examples 1-19.

In various embodiments, one or more operations discussed with reference to FIG. 1 et seq. may be performed by one or more components (interchangeably referred to herein as “logic”) discussed with reference to any of the figures.

In various embodiments, the operations discussed herein, e.g., with reference to FIG. 1 et seq., may be implemented as hardware (e.g., logic circuitry), software, firmware, or combinations thereof, which may be provided as a computer program product, e.g., including one or more tangible (e.g., non-transitory) machine-readable or computer-readable media having stored thereon instructions (or software procedures) used to program a computer to perform a process discussed herein. The machine-readable medium may include a storage device such as those discussed with respect to the figures.

Additionally, such computer-readable media may be downloaded as a computer program product, wherein the program may be transferred from a remote computer (e.g., a server) to a requesting computer (e.g., a client) by way of data signals provided in a carrier wave or other propagation medium via a communication link (e.g., a bus, a modem, or a network connection).

Reference in the specification to “one embodiment” or “an embodiment” means that a particular feature, structure, and/or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
a plurality of mining engines to perform one or more operations for a cryptocurrency;
a scheduler to process a first portion of a message for two or more mining engines of the plurality of mining engines; and
pre-computation circuitry to process a second portion of the message for the two or more mining engines.

2. The apparatus of claim 1, further comprising a First In, First Out (FIFO) buffer to store a hash result from the two or more mining engines.

3. The apparatus of claim 1, further comprising a plurality of programmable registers shared amongst the two or more mining engines.

4. The apparatus of claim 1, wherein the pre-computation circuitry is to process the second portion of the message by performing multiple rounds of hashing to compress the second portion of the message.

5. The apparatus of claim 1, wherein the first portion of the message comprises a first set of bits from an upper half of the message.

6. The apparatus of claim 1, wherein the second portion of the message comprises a second set of bits from a lower half of the message.

7. The apparatus of claim 1, wherein the message comprises 1024 bits, wherein the first portion of the message comprises 512 bits from an upper half of the message.

8. The apparatus of claim 1, wherein the message comprises 1024 bits, wherein the second portion of the message comprises 512 bits from a lower half of the message.

9. The apparatus of claim 1, wherein each of the two or more mining engines are to perform at least two hashing operations.

10. The apparatus of claim 9, wherein the at least two hashing operations are to be performed in accordance with a Secure Hash Algorithm (SHA).

11. The apparatus of claim 1, wherein the one or more operations comprise one or more of: compression and hashing.

12. The apparatus of claim 1, wherein the cryptocurrency is one of: a Bitcoin, Ethereum, Biance Coin, Tether, and Solana.

13. The apparatus of claim 1, wherein mining system controller circuitry comprises the pre-computation circuitry.

14. The apparatus of claim 1, wherein the plurality of mining engine each comprise at least one processor core.

15. The apparatus of claim 1, wherein a processor, having one or more processor cores, comprises one or more of: the scheduler and the pre-computation circuitry.

16. A method comprising:
performing, at a plurality of mining engines, one or more operations to generate a cryptocurrency;
processing, at a scheduler, a first portion of a message for two or more mining engines of the plurality of mining engines; and
processing, at pre-computation circuitry, a second portion of the message for the two or more mining engines.

17. The method of claim 16, further comprising storing a hash result from the two or more mining engines in a First In, First Out (FIFO) buffer.

18. The method of claim 16, further comprising sharing a plurality of programmable registers amongst the two or more mining engines.

19. The method of claim 16, further comprising the pre-computation circuitry processing the second portion of the message by performing multiple rounds of hashing to compress the second portion of the message.

20. One or more non-transitory computer-readable media comprising one or more instructions that when executed on a processor configure the processor to perform one or more operations to cause:
a plurality of mining engines to perform one or more operations to generate a cryptocurrency;
a scheduler to process a first portion of a message for two or more mining engines of the plurality of mining engines; and
pre-computation circuitry to process a second portion of the message for the two or more mining engines.

21. The one or more computer-readable media of claim 20, further comprising one or more instructions that when executed on the one processor configure the processor to perform one or more operations to cause storage of a hash result from the two or more mining engines in a First In, First Out (FIFO) buffer.

22. The one or more computer-readable media of claim 20, further comprising one or more instructions that when executed on the one processor configure the processor to perform one or more operations to cause sharing of a plurality of programmable registers amongst the two or more mining engines.
